(19) United States
(12) Patent Application Publication
(10) Pub. No.: US 2026/0124953 A1
(43) Pub. Date: May 7, 2026

(54) BUILDING LOAD MANAGEMENT DEVICE AND METHOD

(71) Applicants: HYUNDAI MOTOR COMPANY, SEOUL (KR); KIA CORPORATION, SEOUL (KR)

(72) Inventors: Min Kyu Lee, Hwaseong-si (KR); Hyun Sup Kim, Hwaseong-si (KR); Jae Yun Jung, Hwaseong-si (KR); Jeong Hoon Choi, Hwaseong-si (KR); Na Yeon Park, Hwaseong-si (KR); Dae Gun Ko, Hwaseong-si (KR); Hye Seung Han, Hwaseong-si (KR); Sung Kyu Kim, Hwaseong-si (KR); Bum Su Park, Hwaseong-si (KR)

(73) Assignees: HYUNDAI MOTOR COMPANY, SEOUL (KR); KIA CORPORATION, SEOUL (KR)

(21) Appl. No.: 19/205,094

(22) Filed: May 12, 2025

(30) Foreign Application Priority Data
Nov. 1, 2024 (KR) 10-2024-0153325

(51) Int. Cl. B60L 55/00; B60L 53/63; B60L 53/67; H02J 3/00

(52) U.S. Cl. CPC B60L 55/00; B60L 53/63; B60L 53/67; H02J 3/003; H02J 2103/35; H02J 2105/12

(57) ABSTRACT

A building load management device includes a processor and a memory configured to store one or more programs executed by the processor. The processor includes a first processing unit configured to perform clustering, a second processing unit configured to predict a load of a first building at a future time using the previous building load data, a third processing unit configured to predict a load of a first cluster at the future time, and a fourth processing unit configured to assign a weight to a load prediction value of the first building and a load prediction value of the first cluster using a distance value between a centroid of the first cluster and the first building and calculate a final load prediction value of the first building using the weighted load prediction value of the first building and the weighted load prediction value of the first cluster.

### CROSS REFERENCE TO RELATED APPLICATIONS

This application claims priority to and the benefit of Korean Patent Application No. 10-2024-0153325, filed on Nov. 1, 2024, the disclosure of which is incorporated herein by reference in its entirety.

### BACKGROUND

### 1. Field

One embodiment of the present disclosure relates to a building load management device and method, and more specifically, to a building load management device and method, which are capable of being applied to a vehicle-to-building (V2B) platform.

### 2. Discussion of Related Art

With the advancement of technologies of electric vehicles, a vehicle-to-grid (V2G) technology in which the electric vehicle is regarded as an individual energy storage system (ESS) and connected to a power grid is being developed, and such a V2G technology can be seen as solving a stabilization problem of the demand and supply of the power grid using a battery of the electric vehicle. Depending on where electricity is used, such a technology is called a vehicle-to-home (V2H), a vehicle-to-building (V2B), a V2G, or the like. Among these, the V2B, which supplies power of the battery of the electric vehicle to buildings, is being demonstrated and attempts are being made to commercialize the V2G in the future.

When the required power exceeds a maximum load of a building, contracted power may be increased, which may lead to an increase in a basic electricity rate, and securing available resources for electric vehicles through accurate load prediction is emerging as an important issue as a method for commercializing the V2B.

### SUMMARY

The present disclosure is directed to a building load management device and method, which are capable of predicting an accurate building load.

In addition, the present disclosure is directed to a building load management device and method, which are capable of increasing efficiency of a vehicle-to-building (V2B) by performing charging and discharging control of an electric vehicle through building load prediction.

According to an aspect of the present disclosure, there is provided a building load management device including one or more processors, and a memory configured to store one or more programs executed by the one or more processors, wherein the processor includes a first processing unit configured to perform clustering based on previous building load data stored in the memory to cluster a plurality of buildings and calculate distance values between a centroid of a cluster and buildings included in the cluster, a second processing unit configured to predict a load of a first building at a future time point using the previous building load data, a third processing unit configured to predict a load of a first cluster at the future time point using previous building load data of the first cluster including the first building, and a fourth processing unit configured to assign a weight to a load prediction value of the first building and a load prediction value of the first cluster using a distance value between a centroid of the first cluster and the first building and calculate a final load prediction value of the first building using the weighted load prediction value of the first building and the weighted load prediction value of the first cluster.

The first processing unit may calculate a load pattern for a predetermined previous period from the previous building load data, calculate at least one of a Euclidean distance value from a load average, a feature vector, and a dynamic time warping (DTW) distance value using the load pattern, and cluster the plurality of buildings using at least one of the Euclidean distance value, the feature vector, and the DTW distance value.

The first processing unit may cluster the plurality of buildings by applying at least one of the Euclidean distance value, the feature vector, and the DTW distance value to a K-means algorithm.

The second processing unit may include a first deep learning model trained using first training data including building load data, weather data, and day of the week data for a predetermined previous period of the first building.

The third processing unit may include a second deep learning model trained using second training data including building load data, weather data, and day of the week data for a predetermined previous period of each building included in the first cluster.

The third processing unit may train the second deep learning model by normalizing the building load data of the second training data.

The fourth processing unit may increase a weight of the load prediction value of the first building in proportion to the distance value between the centroid of the first cluster and the first building and decrease the load prediction value of the first cluster.

The fourth processing unit may calculate the final load prediction value of the first building by summing the weighted load prediction value of the first building and the weighted load prediction value of the first cluster.

The processor may calculate a final weekday load prediction value and a final weekend load prediction value of the first building using weekday building load data and weekend building load data, respectively.

The building load management device may further include a fifth processing unit configured to generate charging and discharging schedules of an electric vehicle using the final load prediction value of the first building.

According to another aspect of the present disclosure, there is provided a building load management method, which is performed by a computing device including one or more processors and a memory configured to store one or more programs executed by the one or more processors, the method including performing, by the processor, clustering based on previous building load data stored in the memory and clustering a plurality of buildings, calculating, by the processor, distance values between a centroid of a cluster and buildings included in the cluster, predicting, by the processor, a load of a first building at a future time point using the previous building load data, predicting, by the processor, a load of a first cluster at the future time point using previous building load data of the first cluster including the first building, assigning, by the processor, a weight to a load prediction value of the first building and a load prediction value of the first cluster using a distance value between a centroid of the first cluster and the first building, and calculating, by the processor, a final load prediction value of the first building using the weighted load prediction value of the first building and the weighted load prediction value of the first cluster.

The clustering of the plurality of buildings may include calculating a load pattern for a predetermined previous period from the previous building load data, calculating at least one of a Euclidean distance value from a load average, a feature vector, and a dynamic time warping (DTW) distance value using the load pattern, and clustering the plurality of buildings using at least one of the Euclidean distance value, the feature vector, and the DTW distance value.

The clustering of the plurality of buildings may include applying at least one of the Euclidean distance value, the feature vector, and the DTW distance value to a K-means algorithm to cluster the plurality of buildings.

The predicting of the load of the first building may include predicting a load of the first building using a first deep learning model trained using first training data including building load data, weather data, and day of the week data for a predetermined previous period of the first building.

The predicting of the load of the first cluster may include predicting a load of the first cluster using a second deep learning model trained using second training data including building load data, weather data, and day of the week data for a predetermined previous period of each building included in the first cluster.

The predicting of the load of the first cluster may include normalizing the building load data of the second training data to train the second deep learning model.

The assigning of the weight may include increasing a weight of the load prediction value of the first building in proportion to the distance value between the centroid of the first cluster and the first building and decreasing the load prediction value of the first cluster.

The calculating of the final load prediction value of the first building may include summing the weighted load prediction value of the first building and the weighted load prediction value of the first cluster to calculate the final load prediction value of the first building.

The processor may calculate a final weekday load prediction value and a final weekend load prediction value of the first building using weekday building load data and weekend building load data, respectively.

The method may further include, after the calculating of the final load prediction value of the first building, generating a charging and discharging schedule of an electric vehicle using the final load prediction value of the first building.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings, in which:

FIG. 1 is a view for describing a system for managing power of an electric vehicle according to an embodiment;

FIG. 2 is a configuration block diagram illustrating a building load management device according to an embodiment;

FIG. 3 is a view for describing the operation of the building load management device according to the embodiment;

FIGS. 4, 5, 6, 7, 8, 9, 10, 11, and 12 are views for describing the operation of a first processing unit according to an embodiment;

FIG. 13 is a view for describing the operation of a second processing unit according to an embodiment;

FIG. 14 is a view for describing the operation of a third processing unit according to an embodiment;

FIG. 15 is a view for describing the operation of a fourth processing unit according to an embodiment;

FIG. 16 is a view for describing the operation of a fifth processing unit according to an embodiment; and

FIG. 17 is a flowchart of a building load management method according to an embodiment.

### DETAILED DESCRIPTION

Hereinafter, exemplary embodiments of the present disclosure will be described in detail with reference to the accompanying drawings.

However, the technical spirit of the present disclosure is not limited to some of the described embodiments, but may be implemented in various different forms, and one or more of the components among the embodiments may be used by being selectively coupled or substituted without departing from the scope of the technical spirit of the present disclosure.

In addition, terms (including technical and scientific terms) used in embodiments of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by another component present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, embodiments will be described in detail with reference to the accompanying drawings, and the same or corresponding components are denoted by the same reference numeral regardless of the reference numerals, and overlapping descriptions thereof will be omitted.

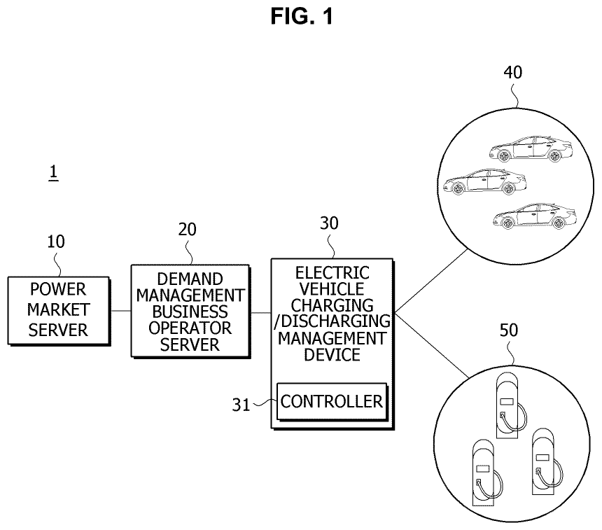

FIG. 1 is a view for describing a system for managing power of an electric vehicle according to an embodiment. Referring to FIG. 1, a system 1 for managing power of an electric vehicle may include an electricity market server 10, a demand management business operator server 20, and a device 30 for managing charging and discharging of an electric vehicle.

The electricity market server 10 is a main device that operates a power market and may perform settlement according to the participation amount of each resource in different ways according to the market settlement rules. The electricity market server 10 may mediate power transactions between the demand management business operator servers 20 using power transaction request information received from a plurality of demand management business operator servers 20.

The electricity market server 10 may be a server that contracts with a demand management business operator to contract power usage and discharge business amount and distributes profits to the demand management business operator through demand response and a power unit price for each time zone.

The demand management business operator server 20 may perform power transaction using charging and discharging information received from the connected device 30 for managing charging and discharging of an electric vehicle, renewable energy generation amount information of a connected renewable energy generation system, and power demand information of a connected system.

In an embodiment, the demand management business operator may be a business operator who contracts with places that use a large amount of electricity, such as a factory, a big building, a parking tower, and the like to perform power consumption reduction or the like according to demand response, thus gaining profits.

The power system connected to the demand management business operator may transmit power demand information to the demand management business operator server 20 at a preset cycle, at the request of the demand management business operator server, or as needed. The power demand information may include the hourly power demand amount and the power usage reduction demand amount of the connected system.

The demand management business operator server 20 may not only respond to a demand response through a power usage reduction request, but also may serve as a power plant that reversely transmits electricity that can be used directly in the system using electric vehicles 40, electric vehicle batteries, an energy storage system (ESS), or the like.

For example, the demand management business operator server 20 may receive a next day's charging and discharging amount of the device 30 for managing charging and discharging of an electric vehicle at a specific time every day, bid the charging and discharging amount to the electricity market server side, receive the contracted amount from the electricity market server 10 according to the preset cycle, and transmit the contracted amount to the device 30 for managing charging and discharging of an electric vehicle.

The device 30 for managing charging and discharging of an electric vehicle may directly manage the electric vehicles 40, charging stations 50 of customers who participate in a vehicle to everything (V2X) service and receive information on the electric vehicles 40 and chargers, plug-in/out signals, and the like. The device 30 for managing charging and discharging of an electric vehicle may determine a next day's charging and discharging bid amount with the goal of maximizing market participation profits and control the charging and discharging of individual electric vehicles 40 to fulfill the contracted amount.

The device 30 for managing charging and discharging of an electric vehicle may monitor information on the electric vehicles 40 and the charging stations 50 and provide various data for customers. The device 30 for managing charging and discharging of an electric vehicle may perform functions of settling bills, managing a parking space, generating and transmitting charging and discharging control instructions, controlling charging and discharging scenarios, diagnosing a battery state of a vehicle, and the like.

The device 30 for managing charging and discharging of an electric vehicle may include a controller 31.

The power system may include, for example, a smart grid-related system such as a substation, a power market server, a demand management business operator server, renewable sources, an ESS, etc. The renewable energy sources may be energy sources using wind power, solar power, geothermal heat, waste, and the like. The power system may supply power within allowable power (or maximum power) Pmax (or allowable AC current IACmax) range to the charging stations 50 under the control of the controller 31.

In some cases, when a plurality of electric vehicles 40 are concentrated on the charging stations 50 in a specific region at the same time, the maximum allowable power of the power system may vary. That is, the electricity market server 10, the demand management business operator server 20 or an energy management system (EMS) that controls the operation of the power system may increase the power capacity by inputting a reserve power source such as an ESS or a nearby renewable energy source and supply the increased power capacity to the charging stations.

The allowable power may be increased under the control of the controller 31 when the power supplied to the electric vehicles 40 is insufficient due to the charging demand information of each electric vehicle 40 (charging demand amounts of electric vehicle users). That is, the controller 31 may control a switch to additionally connect (input) a renewable energy source (or an ESS) within the power system to a substation that supplies power to the charging stations 50 so that the allowable power of the power system increases when a charging load (a load of the electric vehicle) of the charging station 50 exceeds the allowable power of the power system.

The controller 31 may control the overall operation of the components included in the device 30 for managing charging and discharging of an electric vehicle. The controller 31 is an aggregator and may collect the battery capacity of the electric vehicle 40 connected to the charging station 50 through a wired or wireless communication network, a state of charge (SoC) of the battery of the electric vehicle 40, a rated current flowing through a power line, a rated voltage applied to the power line, or the charging demand information of an electric vehicle user (e.g., an owner). The charging demand information of the electric vehicle user may be transmitted to the controller 31 through a communication device included in each of the charging stations 50 or transmitted to the controller 31 through a communication device such as the user's portable phone.

The controller 31 may exchange information with the power system through a wired or wireless communication network and exchange data with the charging station 50 through LAN connection such as Ethernet, power line communication (PLC), or Wi-Fi, which is a wired or wireless communication network.

Based on real-time information of the power system, state information of the electric vehicle 40, and charging demand information of each electric vehicle 40, the controller 31 may control the power of the power system to be supplied to the charging station 50 within the allowable power range of the power system.

The real-time information of the power system may include the allowable power information of the power system or the electricity rate information of the power system, the state information of the electric vehicle 40 may include the SoC information of the battery included in each electric vehicle 40, and the charging demand information may include a charging demand time of an electric vehicle user, a scheduled vehicle entry time, a scheduled vehicle exit time, and a charging demand amount (a target SoC).

The charging station 50 may charge the batteries of the plurality of electric vehicles 40. Each of the charging stations 50 may include an AC limiter that performs a current allocation operation for each electric vehicle 40. In addition, each of the charging stations 50 may include a battery management system (BMS) of the electric vehicle 40 and a control module for exchanging information with the controller 31. Under the control of the controller 31, the control module may control the current limiter (the AC limiter) to provide a DC charging current to the battery of each of the electric vehicles 40.

Each of the electric vehicles 40 may include a BMS. The BMS may control a battery charging process. Each of the electric vehicles 40 may serve as an active load that requests power from the device 30 for managing charging and discharging of an electric vehicle for a charging time.

A charger for converting an AC current into a DC current of the power system to charge the battery of the electric vehicle 40 may be an on-board charger included in each of the electric vehicles 40 or an off-board charger included in each of the charging stations 50.

The electric vehicle 40 may register on a V2X platform and participate in power trading. A user of the electric vehicle 40 may join the platform according to the power market in which he or she wants to participate and register a predicted vehicle entry and exit schedule for the next day. The electric vehicle 40 may transmit information, such as a predicted plug-in time, a predicted plug-out time, SoC information, available battery capacity, etc., to the device 30 for managing charging and discharging of an electric vehicle.

The system 1 for managing power of an electric vehicle is a centralized control system and may adjust charging and discharging schedules of electric vehicles considering the hourly power price, the demand and supply of the power system, or the like. However, as the number of electric vehicles that are a control target increases, the amount of calculation and complexity for optimal scheduling increases.

A building load management device 100 according to the embodiment has a technical effect that can optimize the charging and discharging of such a large-scale electric vehicle fleet. The building load management device according to the embodiment may be included in the configuration of a device for managing charging and discharging of an electric vehicle or provided as a separate device. When the building load management device is provided as a separate device, a separate wired or wireless communication device may be provided to communicate with an electric vehicle, an external server, a terminal, or the like.

The building load management device 100 may receive a value measured from a meter installed on a building through a communication device according to an open charge point protocol (OCPP), process load data for a predetermined period into a table, a graph, or the like, and store the load data in a database.

In an embodiment, an example in which the building load management device is formed as a device separately from the device 30 for managing charging and discharging of an electric vehicle of FIG. 1 will be described.

The building load management device 100 is a platform for implementing a vehicle-to-building (V2B) and is a technology that uses electric vehicle batteries as a power source for a commercial building by supplying power stored in an electric vehicle battery to a building for a time zone when the power demand of the building is high or a power price is high while a building load electric vehicle is being charged in a building parking lot. The building load management device 100 may predict a building load and use available resources of the electric vehicle according to the predicted building load, thereby reducing the load and at the same time, reducing the electricity bill.

In the following embodiment, the building load management device 100 includes a configuration that generates a charging and discharging schedule of an electric vehicle using the building load predicted by the building load management device 100. However, unlike this, the building load management device 100 may be formed as a component that transmits a predicted final building load value to an electric vehicle charging platform and performs charging and discharging scheduling and charging and discharging control on the electric vehicle charging platform.

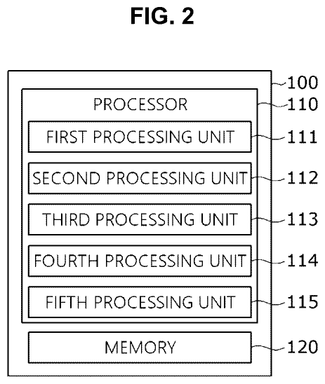

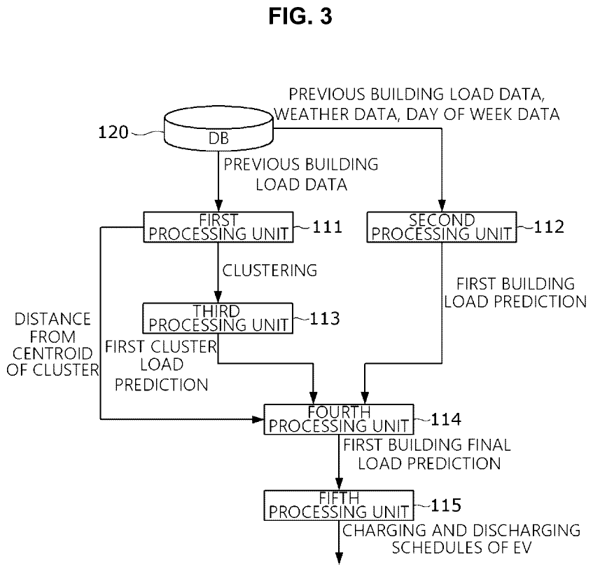

FIG. 2 is a configuration block diagram illustrating a building load management device according to an embodiment, and FIG. 3 is a view for describing the operation of the building load management device according to the embodiment.

Referring to FIGS. 2 and 3, the building load management device 100 may include a processor 110 and a memory 120. In addition, the processor 110 according to the embodiment may include a first processing unit 111, a second processing unit 112, a third processing unit 113, a fourth processing unit 114, and a fifth processing unit 115.

The building load management device 100 according to the embodiment may be implemented in a logic circuit by hardware, firmware, software, or a combination thereof and implemented using a general-purpose or special-purpose computer. The device may be implemented using a hardwired device, a field programmable gate array (FPGA), an application specific integrated circuit (ASIC), etc. In addition, the building load management device 100 may be implemented as an SoC including one or more processors and controllers.

In addition, the building load management device 100 may be mounted on a computing device or server provided with hardware elements in the form of software, hardware, or a combination thereof. The computing device or the server may be various devices including all or some of a communication device such as a communication modem for communicating with various devices or wired and wireless communication networks, a memory in which data for executing a program is stored, a microprocessor for executing a program to perform calculations and instructions, and the like.

The memory 120 may include a database (DB). The memory 120 may be a non-transitory storage medium for storing instructions executed by the processor. The memory 120 may include at least one of a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (cMMC), a universal flash storage (UFS), and/or a web storage.

In an embodiment, the first processing unit 111 to the fifth processing unit 115 may be implemented through the same process, and for convenience of description, the operation of each component will be described separately below.

The processor 110 may include at least one of processing devices such as an ASIC, a digital signal processor (DSP), a programmable logic device (PLD), an FPGA, a central processing unit (CPU), a microcontroller, and/or a microprocessor.

The first processing unit 111 may perform clustering based on previous building load data stored in the memory to cluster a plurality of buildings and calculate distance values between a centroid of a cluster and buildings included in the cluster.

The first processing unit 111 may calculate a load pattern for a predetermined previous period from the previous building load data, calculate at least one of a Euclidean distance value from a load average, a feature vector, and a dynamic time warping (DTW) distance value using the load pattern, and cluster a plurality of buildings using at least one of the Euclidean distance value, the feature vector, and the DTW distance value.

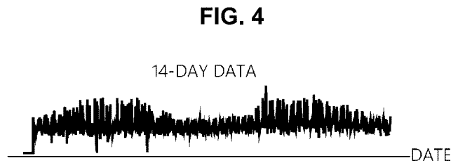

FIGS. 4 to 12 are views for describing the operation of the first processing unit 111 according to an embodiment.

The first processing unit 111 may calculate an average value of power data measured at a specific cycle and stored in the database by time and generate an average pattern of the power data. For example, the first processing unit 111 may generate an average pattern of power data for the previous 14 days measured at 15-minute intervals as illustrated in FIG. 4.

The first processing unit 111 may normalize the average pattern of the power data. The first processing unit 111 may normalize the average pattern of the power data by adapting min-max normalization, z-score normalization, scaling to a range, and robust scaling methods. In an embodiment, an example in which the average pattern of the power data is normalized using the min-max normalization method of converting a minimum value of data to 0 and a maximum value to 1 and normalizing all power values to be within the range of the minimum and maximum values.

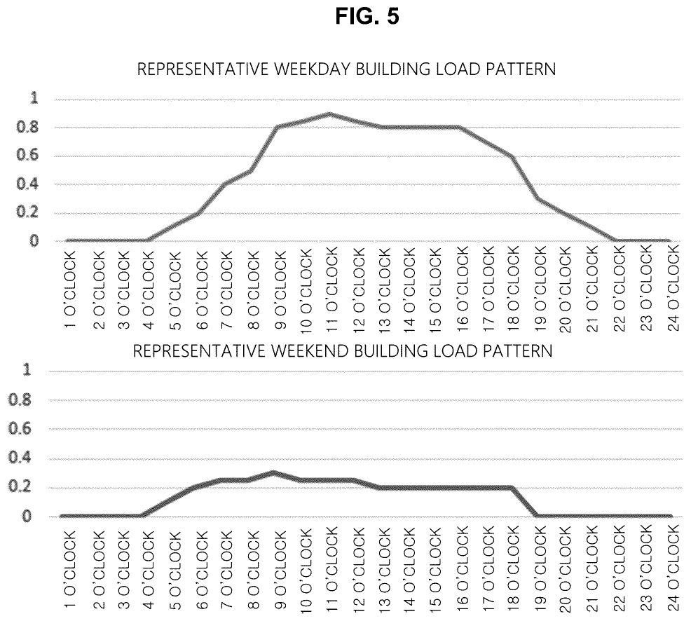

The first processing unit 111 may compare an average pattern of the normalized power data with a representative load pattern stored in the database. Referring to FIG. 5 together, the representative load pattern may refer to data that divides the power usage of a general building load for each time zone and displays the divided power usage. The representative load pattern may be formed based on big data and may refer to data generated by collecting a large amount of power usage patterns of buildings similar to a building to be analyzed and then averaging the power usage patterns. The representative load pattern may be adjusted or changed according to the user's purpose and updated according to data accumulation and analysis.

In an embodiment, the representative load pattern may be classified into weekdays and weekends and stored in the database. In addition, a clustering process, an individual building load prediction process, a cluster load prediction process, and a final building load prediction process, which will be described below, may all be classified into weekdays and weekends and performed. That is, in an embodiment, the processor calculates a final weekday load prediction value and a final weekend load prediction value of a first building using weekday building load data and weekend building load data, respectively.

The first processing unit 111 may calculate a Euclidean distance value between the average pattern of the normalized power data and the representative load pattern. The first processing unit 111 may compare the average value of the normalized power data with the representative power value for each time zone and calculate a distance value for each time zone according to Equation 1 below.

$$D ( x , y ) = \sqrt{{\sum }_{i = 1}^{n} {( {x}_{i} - {y}_{i} )}^{2} )} \qquad Equation 1$$

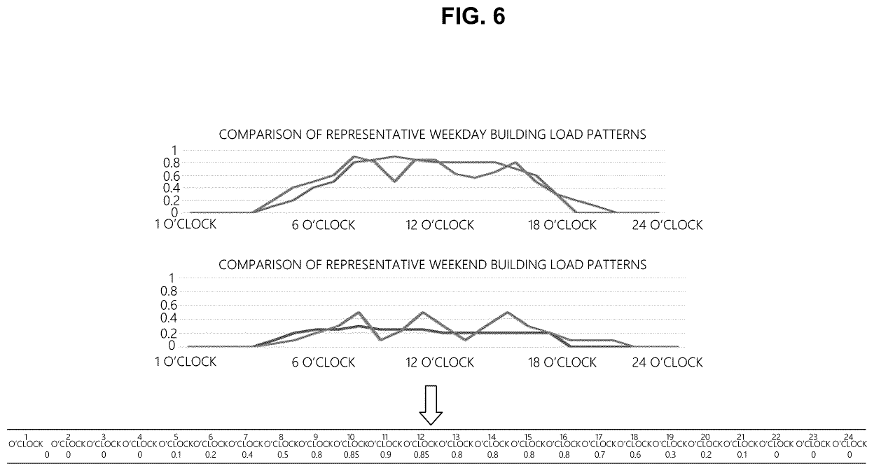

In Equation 1, n denotes 24 (hours), xi denotes a representative power value at an i o'clock, and yᵢ denotes an average value of the normalized power data at the i o'clock. Referring to FIG. 6 together, the first processing unit 111 may compare the average pattern of the normalized power data with the representative load pattern stored in the database and then calculate a Euclidean distance value for each time zone to generate a table.

In addition, the first processing unit 111 may calculate a feature vector from the average pattern of the normalized power data.

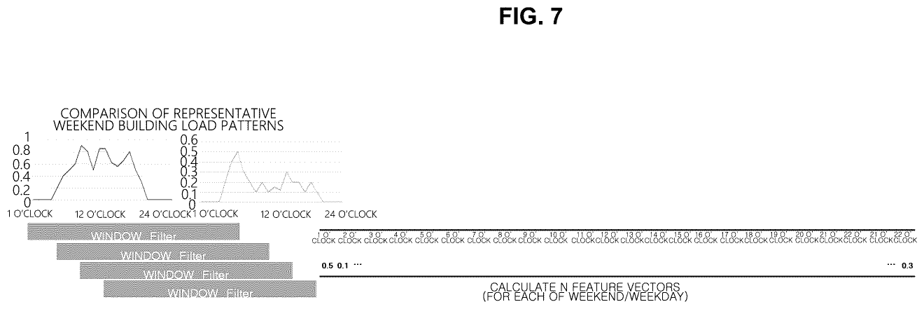

Referring to FIG. 7 together, the first processing unit 111 may calculate a feature vector using a recurrent neural network (RNN). The first processing unit 111 may update a hidden state at each time stage using a time-specific power value of the average pattern of the normalized power data as input data using the sequential characteristics of sequence data and use a final hidden state as a feature vector.

Alternatively, the first processing unit 111 may calculate a feature vector using a convolutional neural network (CNN). The first processing unit 111 may generate a feature map through convolution and pooling to detect a spatial pattern of an imaged graph using a graph of the average pattern of the normalized power data as input data, convert the feature map into a one-dimensional (1D) vector, and use the converted feature map as a feature vector.

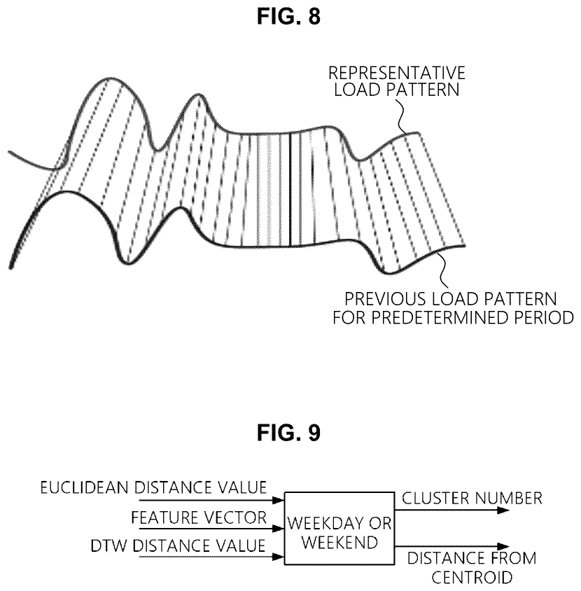

In addition, the first processing unit 111 may calculate a DTW distance value from the average pattern of the normalized power data. Referring to FIG. 8 together, the first processing unit 111 may analyze how similar the average pattern of the normalized power data and the representative load pattern are considering variability (a change in speed, etc.) of time series data through a DTW algorithm.

The first processing unit 111 may calculate a DTW distance value between the average pattern of the normalized power data and the representative load pattern according to Equation 2 below.

$$DTW ( Q , C ) = min \{ \frac{1}{k} \sqrt{{\sum }_{k = 1}^{K} {w}_{k}} \qquad Equation 2$$

In Equation 2, wₖ denotes the Euclidean distance value between the average pattern of the normalized power data at a k o'clock and the representative load pattern, K denotes 24 (hours), Q denotes a vector listing the average value of the normalized power data for each time zone, and C denotes a vector listing the power value of the representative load pattern for each time zone. The first processing unit 111 may calculate a DTW distance value DTW (Q, C) through a process of repeatedly expanding the two vectors Q and C into a set of common moments so that the sum of Euclidean distances wₖ between the corresponding points has the smallest value.

Referring to FIG. 9 together, the first processing unit 111 may cluster a plurality of buildings by applying at least one of the Euclidean distance value, the feature vector, and the DTW distance value to a K-means algorithm. The first processing unit 111 may calculate a Euclidean distance value, a feature vector, and a DTW distance value for previous power data of each of weekdays and weekends and generate each of a cluster for a weekday building load and a cluster for a weekend building load.

K-means clustering is a method of unsupervised learning and is a technique for dividing given data into k clusters. Such an algorithm may assign each data point to the nearest centroid to form a cluster and optimize the quality of clustering by repeatedly recalculating the centroid of each cluster.

In an embodiment, the first processing unit 111 may determine the number of cluster centroids k using an elbow method. The elbow method is a method of finding the optimal number of clusters in K-means clustering and may find a point at which a cost function (within-cluster sum of squares (WCSS) decreases rapidly by evaluating the performance of clustering for each k while changing the value of k in various ways. The first processing unit 111 may generate a graph with k as an x-axis and a WCSS as a y-axis, select a point at which the WCSS decreases rapidly and then a decrease rate becomes smooth as an elbow point, and determine the corresponding k value.

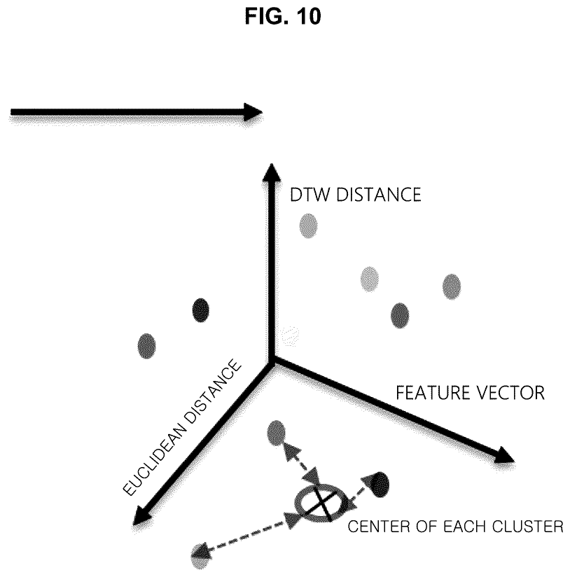

Referring to FIG. 10 together, the first processing unit 111 may randomly select k centroids from a dataset and assign each data point to the closest centroid to form a cluster. In this case, the data point may be represented as coordinates including at least one of a Euclidean distance value, a feature vector, and a DTW distance value. For example, as illustrated in FIG. 10, the data point may be three-dimensional coordinates represented as a Euclidean distance value, a feature vector, and a DTW distance value. The first processing unit 111 may determine the nearest centroid using a distance such as a Euclidean distance.

The first processing unit 111 recalculates the centroid of each cluster as an average of data points belonging to the corresponding cluster and repeats such a process until the centroid no longer changes or the cluster assignment converges.

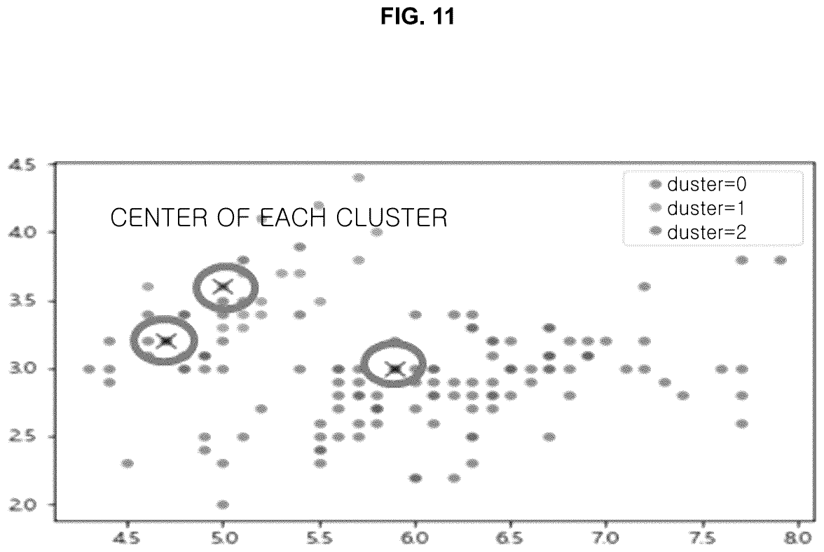

When the centroids do not change or the maximum number of repetitions is reached, the first processing unit 111 may end the algorithm and return the final cluster and the centroids as illustrated in FIG. 11.

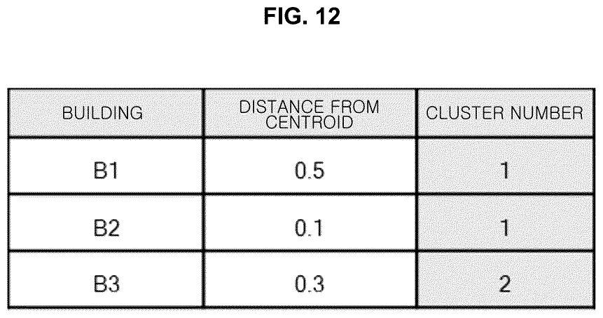

The first processing unit 111 may assign an identification number to each cluster when clustering is completed, calculate distance values between a centroid of each cluster and buildings belonging to the cluster as illustrated in FIG. 12, and store the distance values in the database together with cluster numbers.

The second processing unit 112 may predict a load of the first building at a future time point using previous building load data. In an embodiment, an example in which the first building may be an individual building for predicting a load and the first building belongs to a first cluster will be described.

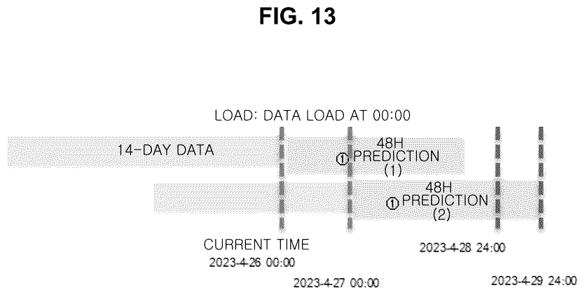

FIG. 13 is a view for describing the operations of the second processing unit 112 according to an embodiment. Referring to FIG. 13 together, the second processing unit 112 may include a first deep learning model trained using first training data including building load data, weather data, and day of the week data for a predetermined previous period of the first building. For example, the first deep learning model may be an artificial neural network model that has trained power data, weather data, and day of the week data for each individual building for the previous 14 days. The first deep learning model may predict a building load for the next 48 hours from the data trained through the trained artificial neural network model.

For example, the second processing unit 112 may predict a building load using extreme gradient boosting (XGBoost), an RNN, a long short-term memory (LSTM) network, a gated recurrent unit (GRU), a CNN, a temporal convolutional network (TCN), a recurrent autoencoder, a variational autoencoder (VAE), a deepAR model, or the like.

The first deep learning model may learn power data, weather data, and day of the week data for a predetermined previous period for each building and output building load prediction information for a predetermined time in the future.

The first deep learning model may be an artificial neural network model that learns the correlation between training data and the building load using the previous power data, weather data, and day of the week data stored in the database as the learning data for each building and is trained to output the building load for a predetermined period in the future using a model trained for a predetermined previous period based on the corresponding time point when a specific time point is input.

In an embodiment, the weather data may include information on temperature, humidity, irradiance, cloudiness, and the like, and the day of the week data may include information that may classify weekdays, weekends, public holidays, and the like.

The second processing unit 112 may train training data collected for several months or several years to generate the first deep learning model. For example, the second processing unit 112 may generate the first deep learning model by repeating training until a result of training converges within a predefined error range or until the number of times specified by a user is reached.

The second processing unit 112 may evaluate the first deep learning model using a mean absolute percentage error (MAPE). The second processing unit 112 may calculate the MAPE according to Equation 3 below.

$$MAPE = \frac{100}{n} {\sum }_{i = 1}^{n} \frac{\vert {w}_{i} - {\hat{w}}_{i} \vert}{{w}_{i}} \qquad Equation 3$$

In Equation 3, n denotes the number of samples, wᵢ denotes a measured value [kw] of a load of an i^{th} building, and ŵᵢ denotes a predicted value [kw] of the load of the i^{th} building. The second processing unit 112 may repeat training so that an MAPE value satisfies a reference value and predict a load of a first building using the deep learning model that satisfies the reference value.

In this case, the first deep learning model may be generated for each building.

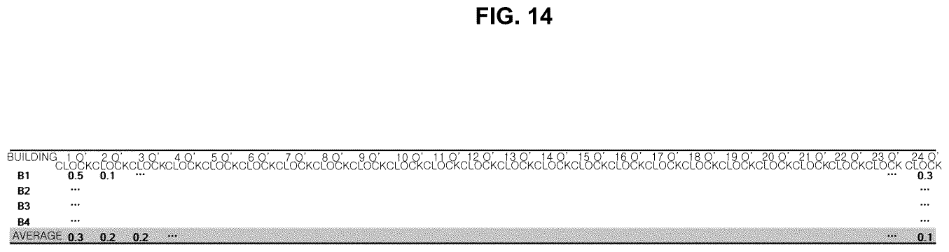

FIG. 14 is a view for describing the operation of the third processing unit 113 according to an embodiment. Referring to FIG. 14 together, the third processing unit 113 may predict the load of the first cluster at a future time point using the previous building load data of the first cluster including the first building. The load of the first cluster may refer to an average value of loads of all buildings belonging to the first cluster.

The third processing unit 113 may include a second deep learning model trained using second training data including building load data, weather data, and day of the week data for a predetermined previous period for each building included in the first cluster. In this case, the third processing unit 113 may train the second deep learning model by normalizing the building load data of the second training data.

For example, the second deep learning model may be an artificial neural network model that learns power data, weather data, and day of the week data for each cluster for the previous 14 days. The second deep learning model may predict a cluster load for the next 48 hours from the data trained through the trained artificial neural network model.

For example, the third processing unit 113 may predict a cluster load using XGBoost, an RNN, an LSTM) network, a GRU, a CNN, a TCN, a recurrent autoencoder, a VAE, a deepAR model, or the like.

The second deep learning model may learn power data, weather data, and day of the week data for a predetermined previous period for each cluster and output cluster load prediction information for a predetermined time in the future.

The second deep learning model may be an artificial neural network model that normalizes the previous power data, weather data, and day of the week data stored in the database, then learns the correlation between training data and the cluster load using the normalized data as learning data for each cluster and is trained to output the cluster load for a predetermined period in the future using the model trained for a predetermined previous period based on the corresponding time point when a specific time point is input.

In an embodiment, the weather data may include information on temperature, humidity, irradiance, cloudiness, and the like, and the day of the week data may include information that may classify weekdays, weekends, public holidays, and the like.

The third processing unit 113 may train training data collected for several months or several years to generate the second deep learning model. For example, the third processing unit 113 may generate the second deep learning model by repeating training until a result of training converges within a predefined error range or until the number of times specified by a user is reached.

The third processing unit 113 may evaluate the first deep learning model using an MAPE. The third processing unit 113 may calculate the MAPE according to Equation 4 below.

$$MAPE = \frac{100}{n} {\sum }_{i = 1}^{n} \frac{\vert {y}_{i} - {\hat{y}}_{i} \vert}{{y}_{i}} \qquad Equation 4$$

In Equation 4, n denotes the number of samples, yᵢ denotes a measured value [kw] of a load of an i^{th} cluster, and ŷᵢ denotes a predicted value [kw] of the load of the i^{th} cluster. The third processing unit 113 may repeat training so that an MAPE value satisfies a reference value and predict a load of a first cluster using the deep learning model that satisfies the reference value.

In this case, the second deep learning model may be generated for each cluster.

The fourth processing unit 114 may assign a weight to a load prediction value of the first building and a load prediction value of the first cluster using a distance value between a centroid of the first cluster and the first building and calculate a final load prediction value of the first building using the weighted load prediction value of the first building and the weighted load prediction value of the first cluster.

The fourth processing unit 114 may increase the weight of the load prediction value of the first building in proportion to the distance value between the centroid of the first cluster and the first building and decrease the load prediction value of the first cluster. When the distance between the centroid of the first cluster and the first building is great, it may mean that the influence of the first cluster on the first building is relatively small. Accordingly, the fourth processing unit 114 may relatively decrease the load prediction value of the first cluster as the distance value increases, thereby reducing the influence of the load prediction value of the first cluster on the final load prediction value.

The fourth processing unit 114 may decrease a weight of the load prediction value of the first building in inverse proportion to the distance value between the centroid of the first cluster and the first building and increase the load prediction value of the first cluster. When the distance between the centroid of the first cluster and the first building is small, it may mean that the influence of the first cluster on the first building is relatively great. Accordingly, the fourth processing unit 114 may relatively increase the load prediction value of the first cluster as the distance value decreases, thereby increasing the influence of the load prediction value of the first cluster on the final load prediction value.

The fourth processing unit 114 may calculate the final load prediction value of the first building by summing the load prediction value of the first building with the weight assigned and the load prediction value of the first cluster. In this case, since the load prediction value of the first cluster is a normalized value, the fourth processing unit 114 may calculate the final load prediction value of the first building by multiplying the load prediction value of the first cluster by a scaling factor.

For example, the fourth processing unit 114 may calculate the final load prediction value of the first building according to Equation 5 below.

$${P}_{B , E} = \frac{d \times {P}_{1}}{w \times {P}_{1}} + \frac{( 1 - d ) \times {P}_{1} \times {P}_{2}}{( 1 - w ) \times {P}_{1} \times {S}_{f}} \qquad Equation 5$$

In Equation 5, P_{B,E} denotes the final load prediction value of the first building, d denotes the distance value between the first building and the centroid of the first cluster, P₁ denotes the load prediction value of the first building, P₂ denotes the load prediction value of the first cluster, w denotes a weight, and s_{f} denotes a scaling factor. The scaling factor may be a maximum value of the load prediction value of the first building.

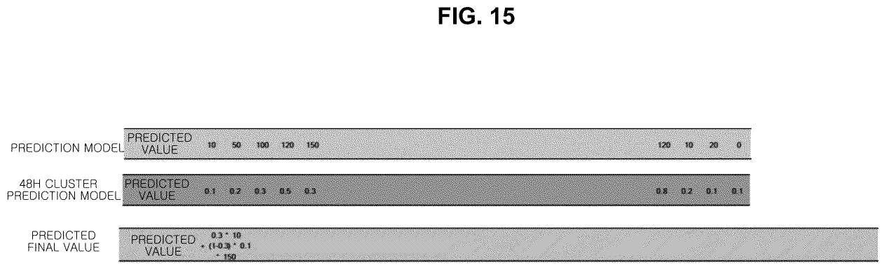

FIG. 15 is a view for describing the operation of the fourth processing unit 114 according to an embodiment. Referring to FIG. 15 together, the fourth processing unit 114 may adjust the scale of the normalized load prediction value of the first cluster by multiplying the load prediction value of the first cluster by the maximum value of the load prediction value of the first building. The fourth processing unit 114 may assign a weight to the load prediction value of the first building and the load prediction value of the first cluster using the distance value between the centroid of the first cluster and the first building and calculate the final load prediction value of the first building by summing the weighted load prediction value of the first building and the weighted load prediction value of the first cluster.

The fifth processing unit 115 may generate a charging and discharging schedule of the electric vehicle using the final load prediction value of the first building. The fifth processing unit 115 may generate a charging and discharging schedule of the electric vehicle using the final load prediction value of the first building.

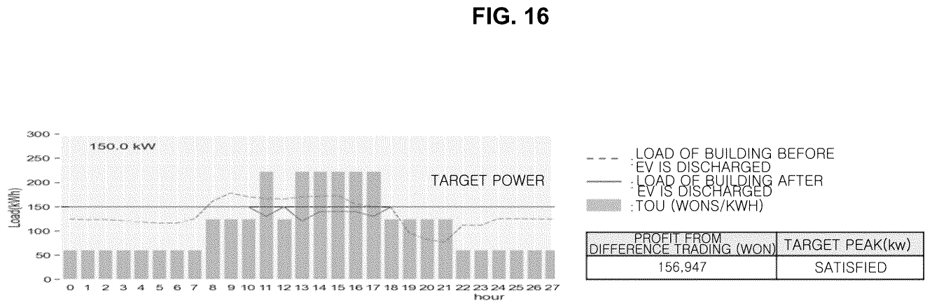

FIG. 16 is a view for describing the operation of the fifth processing unit 115 according to an embodiment. Referring to FIG. 16 together, the fifth processing unit 115 may predict in advance whether peak power exceeding target power (a maximum value of the previous year) occurs according to the final load prediction value of the first building and when the occurrence of the peak power is predicted, the fifth processing unit 115 may generate charging and discharging schedules so that the discharged power of the electric vehicle connected to the first building is supplied to the first building through the V2B. Accordingly, a power charge of the building can be reduced, and a profit from difference trading can be achieved based on a time of use (TOU) based on the reference of not exceeding the target power.

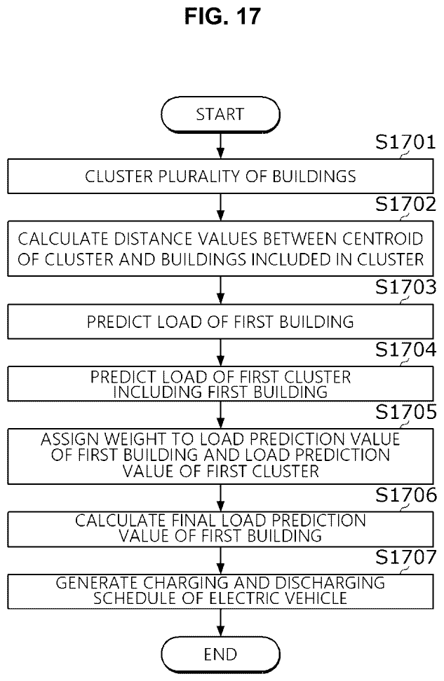

FIG. 17 is a flowchart of a building load management method according to an embodiment. Referring to FIG. 17, a processor may perform clustering based on previous building load data stored in a memory to cluster a plurality of buildings (S1701).

Next, the processor may calculate distance values between a centroid of a cluster and buildings included in the cluster (S1702).

Next, the processor may predict a load of a first building at a future time point using the previous building load data (S1703).

The processor may predict a load of a first cluster at the future time point using previous building load data of the first cluster including the first building (S1704).

The load prediction of the first building and the load prediction of the first cluster may be performed simultaneously or one load prediction may be performed prior to the other load prediction.

Next, the processor may assign a weight to a load prediction value of the first building and a load prediction value of the first cluster using a distance value between a centroid of a first cluster and the first building (S1705).

Next, the processor may calculate a final load prediction value of the first building using the weighted load prediction value of the first building and the weighted load prediction value of the first cluster (S1706).

Next, the processor may generate charging and discharging schedules of the electric vehicle using the final load prediction value of the first building (S1707).

The term “unit” used in the present embodiment means a software or hardware component such as an FPGA or an ASIC, and the “unit” performs certain roles. However, the “unit” is not limited to software or hardware. The “unit” may be disposed in an addressable storage medium and configured to reproduce one or more processors. Therefore, as an example, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

According to a building load management device and method according to embodiments, it is possible to greatly increase prediction accuracy of a building load.

In addition, it is possible to greatly increase profitability of a V2B by adjusting a charging and discharging schedule of an electric vehicle using a result of predicting a building load.

In addition, it is possible to greatly increase load prediction accuracy for new buildings with insufficient previous training data.

In addition, it is possible to greatly reduce the amount of calculation for building load prediction.

Although the present disclosure has been described above with reference to exemplary embodiments, those skilled in the art will understand that the present disclosure may be modified and changed variously without departing from the spirit and scope of the present disclosure as described in the appended claims.

1. A building load management device comprising:
a memory storing computer-executable instructions; and at least one processor configured to access the memory and execute the instructions, wherein the processor comprises: a first processing unit configured to perform clustering based on previous building load data stored in the memory to cluster a plurality of buildings, and to calculate distance values between a centroid of a cluster and buildings included in the cluster;
a second processing unit configured to predict a load of a first building at a future time using the previous building load data;
a third processing unit configured to predict a load of a first cluster at the future time using previous building load data of the first cluster including the first building;
a fourth processing unit configured to assign a weight to a load prediction value of the first building, and a load prediction value of the first cluster using a distance value between a centroid of the first cluster and the first building and calculate a final load prediction value of the first building using the weighted load prediction value of the first building and the weighted load prediction value of the first cluster; and
a fifth processing unit configured to generate a charging and discharging schedule of an electric vehicle using the final load prediction value of the first building.

2. The building load management device of claim 1, wherein the first processing unit is configured to:
calculate a load pattern for a predetermined previous period from the previous building load data calculate at least one of a Euclidean distance value from a load average, a feature vector, and a dynamic time warping (DTW) distance value using the load pattern; and
cluster the plurality of buildings using at least one of the Euclidean distance value, the feature vector, and the DTW distance value.

3. The building load management device of claim 2, wherein the first processing unit is configured to cluster the plurality of buildings by applying at least one of the Euclidean distance value, the feature vector, and the DTW distance value to a K-means algorithm.

4. The building load management device of claim 1, wherein the second processing unit includes a first deep learning model trained using first training data including building load data, weather data, and day of a week data for a predetermined previous period of the first building.

5. The building load management device of claim 1, wherein the third processing unit includes a second deep learning model trained using second training data including building load data, weather data, and day of a week data for a predetermined previous period of each building included in the first cluster.

6. The building load management device of claim 5, wherein the third processing unit is configured to train the second deep learning model by normalizing the building load data of the second training data.

7. The building load management device of claim 1, wherein the fourth processing unit is configured to increase a weight of the load prediction value of the first building in proportion to the distance value between the centroid of the first cluster and the first building, and to decrease the load prediction value of the first cluster.

8. The building load management device of claim 1, wherein the fourth processing unit is configured to calculate the final load prediction value of the first building by adding the weighted load prediction value of the first building and the weighted load prediction value of the first cluster.

9. The building load management device of claim 1, wherein the processor is configured to calculate a final weekday load prediction value of the first building using weekday building load, and a final weekend load prediction value of the first building using weekend building load data.

10. The building load management device of claim 1, wherein the processor is configured to transmit the charging and discharging schedule to an external server.

11. A building load management method, which is performed by a computing device including a memory storing computer-executable instructions; and
at least one processor configured to access the memory and execute the instructions, wherein the instructions comprise:
performing, by the processor, clustering based on previous building load data stored in the memory and clustering a plurality of buildings;
calculating, by the processor, distance values between a centroid of a cluster and buildings included in the cluster;
predicting, by the processor, a load of a first building at a future time using the previous building load data;
predicting, by the processor, a load of a first cluster at the future time point using previous building load data of the first cluster including the first building;
assigning, by the processor, a weight to a load prediction value of the first building and a load prediction value of the first cluster using a distance value between a centroid of the first cluster and the first building;
calculating, by the processor, a final load prediction value of the first building using the weighted load prediction value of the first building and the weighted load prediction value of the first cluster; and
generating a charging and discharging schedule of an electric vehicle using the final load prediction value of the first building.

12. The method of claim 11, wherein clustering of the plurality of buildings includes:
calculating a load pattern for a predetermined previous period from the previous building load data;
calculating at least one of a Euclidean distance value from a load average, a feature vector, and a dynamic time warping (DTW) distance value using the load pattern; and
clustering the plurality of buildings using at least one of the Euclidean distance value, the feature vector, and the DTW distance value.

13. The method of claim 12, wherein clustering of the plurality of buildings includes applying at least one of the Euclidean distance value, the feature vector, and the DTW distance value to a K-means algorithm to cluster the plurality of buildings.

14. The method of claim 11, wherein predicting of the load of the first building includes predicting a load of the first building using a first deep learning model trained using first training data including building load data, weather data, and day of a week data for a predetermined previous period of the first building.

15. The method of claim 11, wherein predicting of the load of the first cluster includes predicting a load of the first cluster using a second deep learning model trained using second training data including building load data, weather data, and day of a week data for a predetermined previous period of each building included in the first cluster.

16. The method of claim 15, wherein predicting of the load of the first cluster includes normalizing the building load data of the second training data to train the second deep learning model.

17. The method of claim 11, wherein assigning of the weight includes increasing a weight of the load prediction value of the first building in proportion to the distance value between the centroid of the first cluster and the first building, and decreasing the load prediction value of the first cluster.

18. The method of claim 11, wherein calculating of the final load prediction value of the first building includes summing the weighted load prediction value of the first building and the weighted load prediction value of the first cluster to calculate the final load prediction value of the first building.

19. The method of claim 11, wherein processor calculates a final weekday load prediction value of the first building using weekday building load data, and a final weekend load prediction value of the first building using weekend building load data.

20. A building load management method, which is performed by a computing device including a memory storing computer-executable instructions; and
at least one processor configured to access the memory and execute the instructions, wherein the instructions comprise:
performing, by the processor, clustering based on previous building load data stored in the memory and clustering a plurality of buildings;
calculating, by the processor, distance values between a centroid of a cluster and buildings included in the cluster;
predicting, by the processor, a load of a first building at a future time using the previous building load data;
predicting, by the processor, a load of a first cluster at the future time point using previous building load data of the first cluster including the first building;
assigning, by the processor, a weight to a load prediction value of the first building and a load prediction value of the first cluster using a distance value between a centroid of the first cluster and the first building;
calculating, by the processor, a final load prediction value of the first building using the weighted load prediction value of the first building and the weighted load prediction value of the first cluster;
transmitting a predicted final building load value to an electric vehicle charging platform; and
performing charging and discharging scheduling, and charging and discharging control on the electric vehicle charging platform.
